(19) United States
(12) Patent Application Publication
(10) Pub. No.: US 2004/0076924 A1
(43) Pub. Date: Apr. 22, 2004

(54) Dental implant abutment apparatus

(76) Inventor: Soo Hong Kim, Pusan (KR)

Correspondence Address: JACOBSON HOLMAN PLLC, 400 SEVENTH STREET N.W., SUITE 600, WASHINGTON, DC, 20004, US

(21) Appl. No.: 10/346,110

(22) Filed: Jan. 17, 2003

(30) Foreign Application Priority Data
Oct. 17, 2002 (KR) 2002-0063507

(51) Int. Cl. A61C 8/00

(52) U.S. Cl. 433/173

(57) ABSTRACT

Disclosed is a dental implant abutment apparatus suited for use when a dentist simultaneously implants at least two artificial teeth in the alveolar bone of a patient. The dental implant abutment apparatus has an upper supporting member and a lower supporting member, in which the upper supporting member includes an artificial tooth installation part and a threaded portion integrally formed with each other, the lower supporting member is installed between the upper supporting member and an artificial tooth fixture to be implanted in the alveolar bone. An artificial tooth may be attached to a radial outer periphery surface of the upper supporting member by means of dental cement. There is an advantage in that it is possible to prevent the artificial tooth from being shaken or broken by always maintaining a stable engagement although an impact is repeatedly applied to the artificial tooth while a person having the artificial tooth chews his or her food well.

### BACKGROUND OF THE INVENTION

1. Field of the Invention

The present invention relates to a dental implant abutment apparatus, and more particularly to a dental implant abutment apparatus suited for use when a dentist simultaneously implants at least two artificial teeth in the alveolar bone of a patient, which has an upper supporting member and a lower supporting member, in which the upper supporting member includes an artificial tooth installation part and a threaded portion integrally formed with each other, the lower supporting member is installed between the upper supporting member and an artificial tooth fixture to be implanted in the alveolar bone, wherein an artificial tooth may be attached to a radial outer periphery surface of the upper supporting member by means of dental cement, which is capable of preventing the artificial tooth from being shaken or broken by always maintaining a stable engagement although an impact is repeatedly applied to the artificial tooth while a person having the artificial tooth chews his or her food well.

2. Description of the Related Art

Generally, a dental implant is what is called a substitute for a natural tooth that is lost as a result of dental disease, or a surgical implantation for recovering a natural function of the natural tooth by fixing a dental prosthesis including an abutment and a crown to the tooth after implanting a threw-shaped artificial fixture in the alveolar bone and then melting it into the alveolar bone.

Typically, two types of surgical implantations in the dental implant have been developed. One type of surgical implantation in the dental implant is that an abutment is mounted in or on a root member and a crown is then mounted on the abutment. If one natural tooth of an individual is lost as a result of dental disease or trauma, the natural tooth may be replaced with one artificial tooth by using this type of surgical implantation.

The other type of surgical implantation is what is called “bridge technique”, which is particularly suited for use when at least two teeth are simultaneously lost as a result of dental disease or trauma. If at least two teeth located adjacent with each other are simultaneously lost or two natural teeth are lost but one tooth located there between is not lost, two artificial teeth for substituting the two damaged natural teeth are connected with each other by using a dental prosthesis.

FIGS. 1 and 2 illustrate a dental implant abutment apparatus according to the related art. As shown in FIGS. 1 and 2, a reference numeral 11 denotes an artificial tooth fixture having a hexagonal head portion 12 at its upper end. An engaging hole 13 having a female threaded portion is formed in the artificial tooth fixture 11. Furthermore, a reference numeral 1 denotes a dental implant abutment apparatus to be installed at the upper end of the artificial tooth fixture 11. The dental implant abutment apparatus 1 comprises an artificial tooth supporting member 21 and a fixation screw 25 to anchor the artificial tooth-supporting member 21 to the artificial tooth fixture 11.

An inserting hole 22 is formed in the artificial tooth-supporting member 21 and also a hexagonal bore 24 is formed in the artificial tooth-supporting member 21 in communication with the inserting hole 22. A shoulder portion 23 is formed between a lower end of the inserting hole 22 and an upper end of the hexagonal bore 24. The fixation screw 25 is provided with a head portion 26 and a threaded portion 27. A hexagonal wrench bore 26a is formed at an upper center portion of the head portion 26.

Hereinafter, an assembling process of the dental implant abutment apparatus 1 according to the related art will be described in detail.

As shown in FIG. 2, the artificial tooth-supporting member 21 is mounted onto the artificial tooth fixture 11 struck in a jawbone. At this time, the hexagonal head portion 12 formed at the upper end of the artificial tooth fixture 11 is positioned in the hexagonal bore 24 of the artificial tooth-supporting member 21. Thereafter, the threaded portion 27 of the fixation screw 25 is received through insertion hole 22 and the hexagonal bore 24 of the artificial tooth-supporting member 21 into the engaging hole 13 of the artificial tooth fixture 11.

In order to make the artificial tooth-supporting member 21 to be firmly mounted onto the artificial tooth fixture 11, a predetermined engaging tool (not shown) having a protrusion is engaged in the hexagonal wrench bore 26a formed at the upper end of the head portion 26 in the fixation screw 25. After mounting the artificial tooth-supporting member 21 onto the artificial tooth fixture 11 using the fixation screw 25 and the engaging tool (not shown), an artificial tooth 14 is firmly attached to the radial outer periphery surface of the artificial tooth-supporting member 21 by using dental cement.

In the bridge type of dental implant abutment apparatus 1 according to the related art, however, there are some problems that the tightening force given by the fixation screw 25 for fixing the artificial tooth supporting member 21 on the artificial tooth fixture 11 is weaken and further the fixation screw 25 may be broken while a person having the artificial tooth implanted by using the prior dental implant abutment apparatus chews his or her food well.

If a person having the artificial tooth implanted by using the dental implant abutment apparatus 1 repeatedly chews his or her food well, as shown in FIG. 2, the artificial tooth 14 is subjected to a lateral uniting force (F), which is created by another tooth (not shown) to be engaged with the artificial tooth 14. At this time, a first point of action for the lateral uniting force (F) is “A” at which the artificial tooth-supporting member 21 is continuously contacted with the artificial tooth fixture 11. A moment arm of a moment produced by the lateral uniting force (F) is set as the height “d” from a horizontal line, which extends from the first point of action “A”, to an arrow illustrating the lateral uniting force (F). This moment continuously acts on the fixation screw 25 that is engaged in the engaging hole 13 of the artificial tooth fixture 11. At this time, a second point of action of the moment is “B” at which the low end of the head portion 26 of the fixation screw 25 is continuously contacted with the upper surface of the shoulder portion 23 of the artificial tooth-supporting member 21.

In the conventional dental implant abutment apparatus 1, however, the moment produced from the lateral uniting force (F) may be always applied to the fixation screw 25 for fixing the artificial tooth-supporting member 21. As a result, an engaging force of the fixation screw 25 is weakened and thereby the artificial tooth-supporting member 21 may be shaken. Consequently, a dental prosthesis of which at least two artificial teeth are connected with each other by using the bridge technique is also shaken. Another problem associated with the prior dental implant abutment apparatus is that a stress may be concentrated at a point at which the head portion 26 of the fixation screw 25 is contacted with the threaded portion 27, and thereby the conventional dental implant abutment apparatus 1 may be easily broken.

As described above, the conventional dental implant abutment apparatus 1 has some problems in that the durability thereof remarkably deteriorates and thereby it has a short life. Furthermore, in order to remove a broken implant and to replace it with new implant, a significant investment is required in time and money by dental professionals.

### SUMMARY OF THE INVENTION

The present invention has been made to solve the above-mentioned problem, and accordingly it is the object of the present invention to provide a dental implant abutment apparatus suited for use when a dentist simultaneously implants at least two artificial teeth in the alveolar bone of a patient, which has an upper supporting member and a lower supporting member, in which the upper supporting member includes an artificial tooth installation part and a threaded portion integrally formed with each other, the lower supporting member is installed between the upper supporting member and an artificial tooth fixture to be implanted in the alveolar bone, wherein an artificial tooth may be attached to a radial outer periphery surface of the upper supporting member by means of dental cement, which is capable of preventing the artificial tooth from being shaken or broken by always maintaining a stable engagement although an impact is repeatedly applied to the artificial tooth while a person having the artificial tooth chews his or her food well.

In order to achieve the object of the present invention, the present invention provides an improved dental implant abutment apparatus of the type in which it is mounted onto an upper end of an artificial tooth fixture, in which a hexagonal head portion is formed at the upper end of the artificial tooth fixture and an engaging hole is formed at the center of the upper end of the artificial tooth fixture, and wherein an artificial tooth may be attached to a radial outer periphery surface of the dental implant abutment apparatus by using a dental cement, the dental implant abutment apparatus, wherein the improvement comprises:

an upper supporting member including an artificial tooth installing part of which an engaging bore for receiving a predetermined engaging tool is vertically formed along its longitudinal direction, a reinforcing neck part and a threaded portion; and

a lower supporting member including an upper inclined portion formed at its outer upper portion and a lower inclined portion formed at its outer lower portion, in which an insertion hole is vertically formed through the lower supporting member, a hexagonal bore is formed at a lower end of the lower supporting member, when the upper supporting member, the lower supporting member and the artificial tooth fixture have been assembled together, the threaded portion of the upper supporting member passes through the insertion hole of the lower supporting member and then further inserted into the engaging hole of the artificial tooth fixture, at this time, the reinforcing neck part is positioned in the insertion hole and the hexagonal head portion of the artificial tooth fixture is engaged in the hexagonal bore of the lower supporting member.

### BRIEF DESCRIPTION OF THE DRAWINGS

The above and other objects and advantages of the present invention will become readily apparent by reference to the following detailed description when considered in conjunction with the accompanying drawings wherein:

FIG. 1 is an exploded perspective view of an implant abutment apparatus according to the related art;

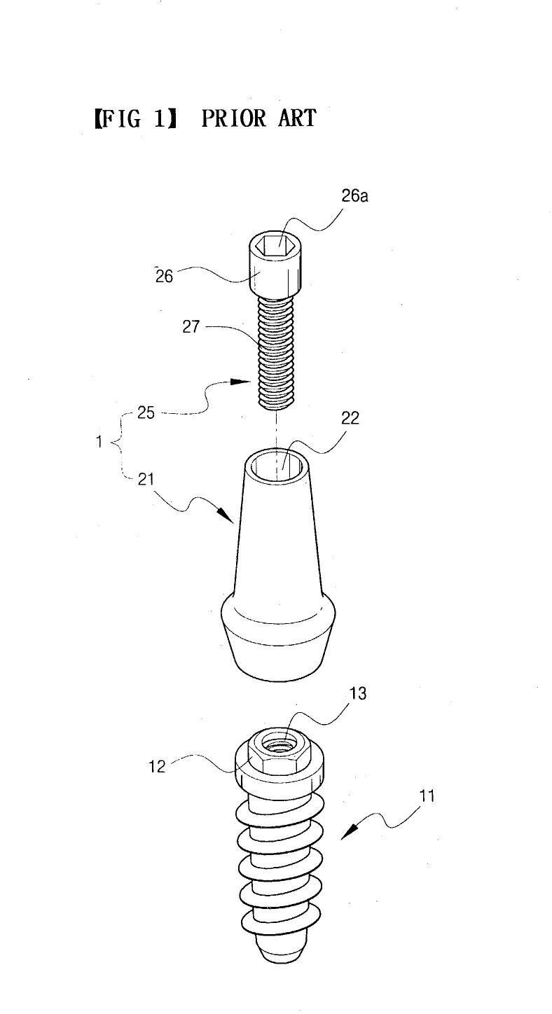

FIG. 2 is a view, partially in vertical section, illustrating an assembled state and an operation of the implant abutment apparatus according to the related art;

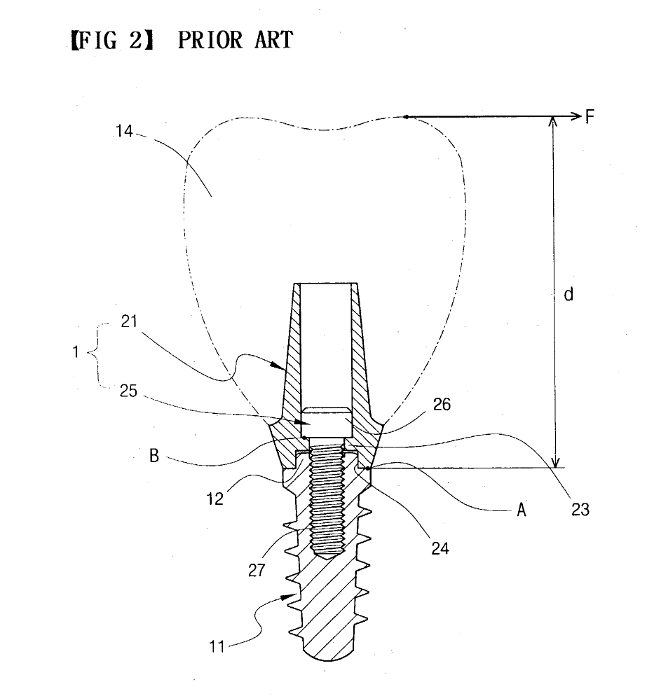

FIG. 3 is an exploded perspective view of an implant abutment apparatus according to a preferred embodiment of the present invention;

FIG. 4 is a view, partially in vertical section, illustrating an assembled state and an operation of the implant abutment apparatus according to the preferred embodiment of the present invention; and.

FIG. 5 is a view illustrating an installation state of the implant abutment apparatus according to the preferred embodiment of the present invention.

### DETAILED DESCRIPTION OF THE PREFERRED EMBODIMENT

Hereinafter, a dental implant abutment apparatus according to the preferred embodiment of the present invention will be described in detail with reference to the accompanying drawings.

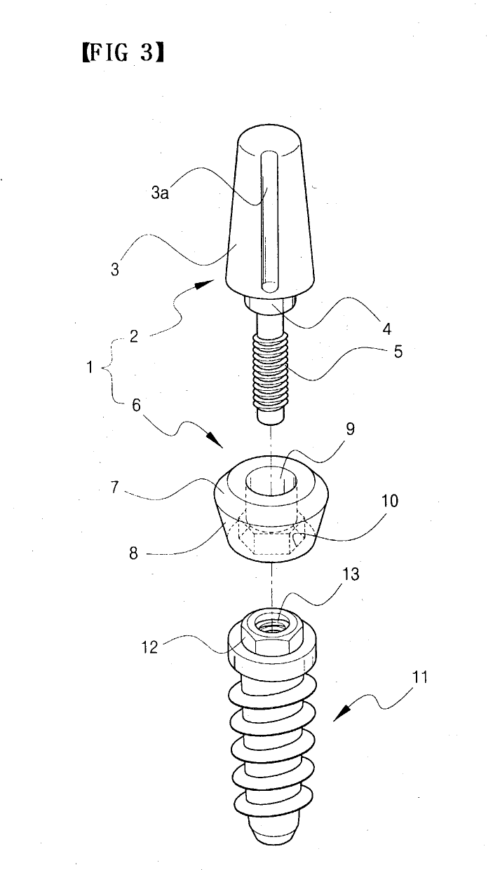

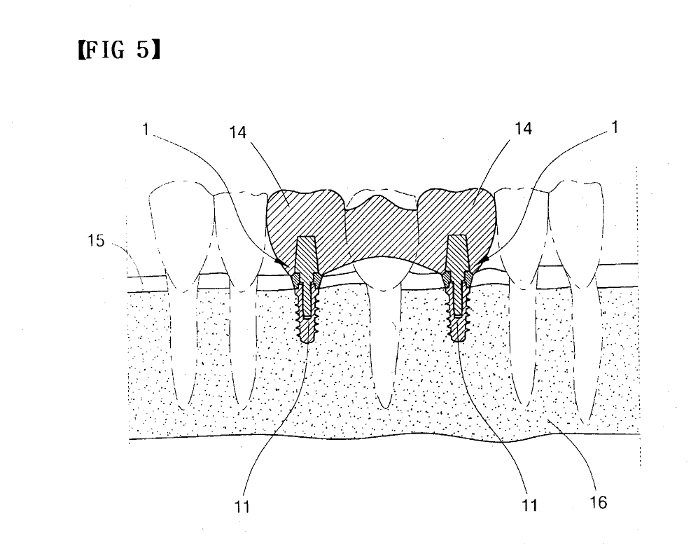

As shown in FIG. 3, a reference numeral 11 denotes an artificial tooth fixture having a hexagonal head portion 12 at its upper end. An engaging hole 13 having a female threaded portion is formed in the artificial tooth fixture. Furthermore, a reference numeral 1 denotes a dental implant abutment apparatus to be installed at the upper end of the artificial tooth fixture 11. An artificial tooth 14 may be attached to a radial outer periphery surface of an artificial tooth installing part 3 of the dental implant abutment apparatus 1 (referred to FIG. 5). At this time, suitable locking means such as dental cement is used to fix the artificial tooth 14 to the radial outer periphery surface of the artificial tooth installing part 3.

The dental implant abutment apparatus 1 comprises an upper supporting member 2 and a lower supporting member 6.

The upper supporting member 2 includes the artificial tooth installing part 3 of which an engaging bore 3a is vertically formed therein along its longitudinal direction, a reinforcing neck part 4 and a threaded portion 5. At this time, the artificial tooth installing part 3, the reinforcing neck part 4 and the threaded portion 5 are integrally formed together. A predetermined engaging tool (not shown) having a protrusion may be engaged in the engaging bore 3a.

The lower supporting member 6 includes an upper inclined portion 7 formed at its upper portion and a lower inclined portion 8 formed at its lower portion. An insertion hole 9 is vertically formed through the lower supporting member 6. A hexagonal bore 10 is formed at a lower end of the lower supporting member 6 in communication with the insertion hole 9.

When the upper supporting member 2, the lower supporting member 6 and the artificial tooth fixture 11 are engaged together, the reinforcing part 4 and the threaded portion 5 of the upper supporting member 2 are received through the insertion hole 9 of the lower supporting member 6 into the engaging hole 13 of the artificial tooth fixture 11. At this time, the hexagonal head portion 12 of the artificial tooth fixture 11 is located in the hexagonal bore 10 of the lower supporting member 6.

Hereinafter, an assembling process and an operation of the dental implant abutment apparatus according to the preferred embodiment of the present invention will be described in detail.

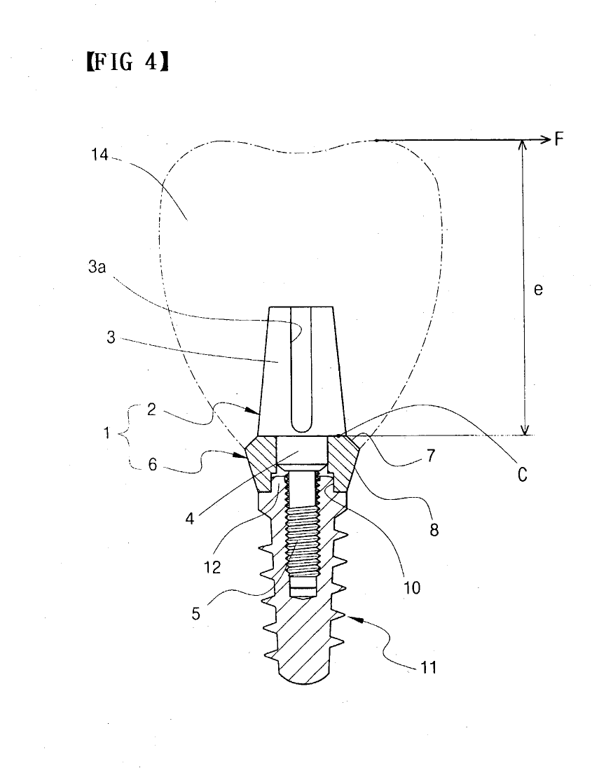

FIG. 4 is a view, partially in vertical section, illustrating an assembled state and an operation of the implant abutment apparatus according to the preferred embodiment of the present invention.

Referring to FIG. 4, as the hexagonal head portion 12 of the artificial tooth fixture 11 is located in the hexagonal bore 10 of the lower supporting member 6, the lower supporting member 6 is mounted onto the artificial tooth fixture 11 struck in a jawbone.

Thereafter, the threaded portion 5 of the upper supporting member 2 is received through the insertion hole 9 of the lower supporting member 6 into the engaging hole 13 of the artificial tooth fixture 11. In order to make the upper supporting member 2 to be firmly mounted onto the artificial tooth fixture 11, an engaging tool (not shown) having a protrusion is engaged in the engaging bore 3a formed at the artificial tooth installation part 3.

After mounting the upper supporting member 2 onto the artificial tooth fixture 11 using the lower supporting member 6, an artificial tooth 14 is firmly attached to the artificial installation part 3 of the upper supporting member 2 by using a dental cement. Since the upper inclined portion 7 of the lower supporting member 6 encloses the lower end of the artificial tooth 14, the lower supporting member 6 is not exposed to the outside. The lower inclined portion 8 of the lower supporting member 6 comes contact with a gum while a cutaway portion of the gum has been healed. Accordingly, it is possible to prevent foreign materials from being introduced into gab between the dental implant abutment apparatus and the gum.

Referring to FIG. 4, meanwhile, the artificial tooth 14 is subjected to a lateral uniting force (F), which is created by another tooth (not shown) to be engaged with the artificial tooth 14 while a person having the artificial tooth 14 implanted by using the dental implant abutment apparatus 1 chews his or her food well. At this time, a first point of action for the lateral uniting force (F) is “C” at which the artificial tooth 14 is continuously contacted with the artificial tooth fixture 11. A moment arm of a moment produced by the lateral uniting force (F) is set as the height “e” from a horizontal line, which extends from the first point of action “C”, to an arrow illustrating the lateral uniting force (F).

At this time, a length of the moment arm of the moment created by the lateral uniting force (F) is relatively reduced as the height of the lower supporting member 6 in comparison with that of the conventional moment arm of the moment created in the conventional dental implant abutment apparatus. Accordingly, if the lateral uniting force (F) is simultaneously applied to the dental implant abutment apparatus according to the present invention and the conventional dental implant abutment apparatus, an influence of the moment about the dental implant abutment apparatus according to the present invention is smaller than that about the conventional dental implant abutment apparatus as the height of the lower supporting member 6. At this time, the moment applied to the dental implant abutment apparatus according to the present invention is supported by the reinforcing neck part 4 having a diameter greater than that of the threaded portion 5 of the artificial tooth fixture 11, which is formed between the artificial tooth installation part 3 of the upper supporting member 2 and the threaded portion 5 of the artificial tooth fixture 11. Consequently, it is possible to prevent the reinforcing neck part 4 from being broken owing to the moment continuously applied thereto.

As described above, the dental implant abutment apparatus 1 according to the present invention is provided with the upper supporting member 2 having the artificial tooth installation part 3 and the threaded portion 5, which are integrally formed with each other. The artificial tooth 14 is mounted to the artificial tooth installation part 3 and the threaded portion 5 is received into the engaging hole 13 of the artificial tooth fixture 11.

As best seen in FIG. 5, since a supplement comprising at least two artificial teeth 14, which are connected with each other using the bridge technique, is firmly fixed to the artificial installation part 3 integrally formed with the threaded portion 5 by means of dental cement, the upper supporting member 2 cannot be rotated. Accordingly, although a certain moment for loosening a threaded engagement may continuously applied to the dental implant abutment apparatus 1 owing to the lateral uniting force (F), it is possible to maintain a stable engagement between the dental implant abutment apparatus 1 and the artificial tooth fixture 11.

As described above, the dental implant abutment apparatus according to the present invention includes the upper supporting member 2 having the artificial tooth installation part 3 and the threaded portion 5, which are integrally formed with each other. The artificial tooth 14 is mounted to the artificial tooth installation part 3 and the threaded portion 5 is engaged in the engaging hole 13 of the artificial tooth fixture 11. Due to this structure, it is possible to prevent the artificial tooth from being shaken or broken by always maintaining a stable engagement although an impact is repeatedly applied to the artificial tooth while a person having the artificial tooth chews his or her food well.

Although the preferred embodiments of the present invention have been described, it is understood that the present invention should not be limited to these preferred embodiments but various changes and modifications can be made by one skilled in the art within the spirit and scope of the present invention aimed.

What is claimed is:

1. An improved dental implant abutment apparatus of the type in which it is mounted onto an upper end of an artificial tooth fixture 11, in which a hexagonal head portion 12 is formed at the upper end of the artificial tooth fixture 11 and an engaging hole 13 is formed at the center of the upper end of the artificial tooth fixture 11, and wherein an artificial tooth 14 may be attached to a radial outer periphery surface of the dental implant abutment apparatus 1 by using a dental cement, the dental implant abutment apparatus, wherein the improvement comprises:
an upper supporting member 2 including an artificial tooth installing part 3 of which an engaging bore 3a for receiving a predetermined engaging tool is vertically formed along its longitudinal direction, a reinforcing neck part 4 and a threaded portion 5; and
a lower supporting member 6 including an upper inclined portion 7 formed at its outer upper portion and a lower inclined portion 8 formed at its outer lower portion, in which an insertion hole 9 is vertically formed through the lower supporting member 6, a hexagonal bore 10 is formed at a lower end of the lower supporting member 6, when the upper supporting member 2, the lower supporting member 6 and the artificial tooth fixture 11 have been assembled together, the threaded portion 5 of the upper supporting member 2 passes through the insertion hole 9 of the lower supporting member 6 and then further inserted into the engaging hole 13 of the artificial tooth fixture 11, at this time, the reinforcing neck part 4 is positioned in the insertion hole 9 and the hexagonal head portion 12 of the artificial tooth fixture 11 is engaged in the hexagonal bore 10 of the lower supporting member 6.
